(19) United States
(12) Patent Application Publication
(10) Pub. No.: US 2004/0107145 A1
(43) Pub. Date: Jun. 3, 2004

(54) Method and system for making purchases over a computer network

(76) Inventors: Vincent C. Skurdal, Boise, ID (US); Mark L. Brown, Boise, ID (US); Marvin Duane Nelson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/308,682

(22) Filed: Dec. 3, 2002

(51) Int. Cl. G06F 17/60

(52) U.S. Cl. 705/26

(57) ABSTRACT

A method of making purchases over a computer network includes accessing an agent site on the network, retrieving product information from at least one supplier site on the network, and recording information regarding products designated for purchase from supplier sites in an electronic shopping cart resident at the agent site.

### BACKGROUND

The ability of the Internet to provide a wide range of services and benefits has drawn an ever-increasing number of users. For example, users of the Internet have near instant access to news and information. Additionally, Internet users can send messages to each other around the world in moments and at little or no expense.

The Internet is also increasingly used as a means to market and sell goods and services to purchasers. The Internet has been used to sell products and services to individuals as well as to companies of all sizes. When the Internet is used to sell goods or services to individual consumers, the transactions are frequently referred to as e-tailing and the sellers as e-tailers. When the Internet is used to make or support transactions between businesses, the result is referred to as business-to-business (or B2B) transactions. Collectively, e-tailing and B2B applications are known as e-commerce.

Typically, on-line shopping incorporates the use of an electronic shopping cart. An electronic shopping cart is an electronic ledger of the items a shopper desires to purchase as selected from among all the items available at a particular website.

Inventory from the on-line store is usually presented in an electronic catalog. The potential customer can navigate through the catalog to see the items available. Typically, such an electronic catalog is organized by product categories. The potential customer may also be able to use a search engine to search the electronic catalog based on keywords or other identifiers. Photographs or illustrations are commonly used to show the items available to the potential customer. The potential customer may also read descriptions of the available items and, perhaps, get other information about the items, such as comments from other purchasers, etc.

Items are placed into the shopping cart, for example, by selecting a designated icon, button or link when the item desired is being displayed and described. Selection of an item is usually performed using a mouse or keyboard. This action places the product, in a desired and specified quantity, into an electronic shopping cart.

Items in the cart can then be reviewed and removed prior to finalizing the purchase. Advantages of the electronic shopping cart concept include an easily recognizable model from the real world that provides to the customer a familiar metaphor with which to understand what is taking place as the electronic transaction progresses.

Each e-commerce site provides its own electronic shopping cart that is used to purchase the items on that site. When shopping at that site is completed, the customer “check's out,” for example, by providing billing and shipping information. The shopping cart is then emptied, the shopper is charged for the items, and the items purchased are scheduled for delivery to the customer.

If a customer also needs items available at another website, the customer must go to that site, sign in and obtain a new electronic shopping cart for that site. The entire process then repeats as the customer obtains the items needed from the second website.

### SUMMARY

A method of making purchases over a computer network preferably includes accessing an agent site on the network, retrieving product information from at least one supplier site on the network, and recording information regarding products designated for purchase from supplier sites in an electronic shopping cart resident at the agent site.

A website comprises a server connected to a computer network and executing an e-commerce application. The e-commerce application causes the server to retrieve product information from at least one supplier site on the network and record information regarding products designated for purchase from supplier sites in an electronic shopping cart resident on the server.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram illustrating a system for providing and using a cross-web shopping cart according to one embodiment of the present invention.

FIG. 2 is a process diagram demonstrating a cross-web shopping cart purchase according to one embodiment of the present invention.

FIG. 3 is a process diagram that demonstrates one payment model for use with the process illustrated in FIG. 2.

FIG. 4 is a process diagram that demonstrates a second payment model for use with the process illustrated in FIG. 2

FIG. 5 is a process diagram that illustrates a method of purchasing components from a parts list according to another embodiment of the present invention.

Throughout the drawings, identical reference numbers designate similar, but not necessarily identical, elements.

### DETAILED DESCRIPTION OF THE EMBODIMENTS

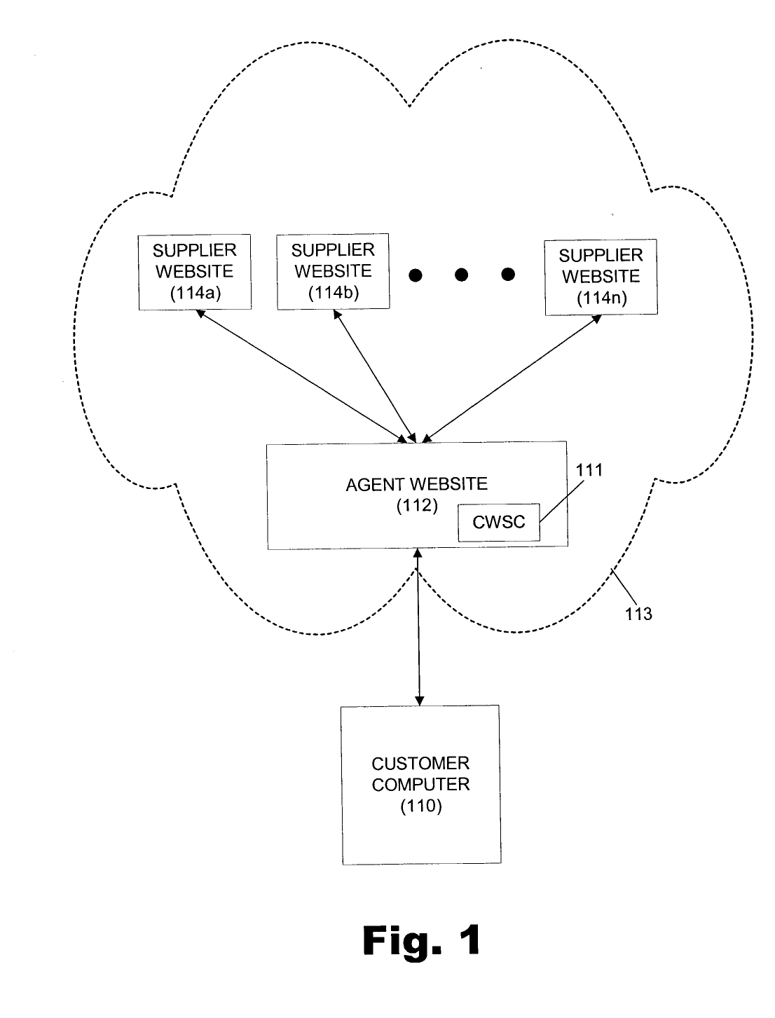

FIG. 1 is a block diagram illustrating a system for providing and using a cross-web shopping cart. As shown in FIG. 1, a customer or potential customer uses a computer (110) that has access to the Internet (113). The computer (110) may be connected to the Internet through any means, including, but not limited to, a Local Area Network (LAN), wireless LAN, Wide Area Network, cable network, etc.

The computer (110) preferably provides a user interface including, for example, a display device and a user input device. The display device may be, for example, a cathode ray tube or a liquid crystal display or other flat panel display. The user input device preferably includes a keyboard and a mouse, trackball, trackpad, etc.

The computer (110) is used for, among other things, conducting e-commerce transactions over the Internet (113). The customer may be an individual or a representative of a business or other organization.

To facilitate the e-commerce transactions the customer wishes to make, the customer uses the computer (110) to access an agent website (112). This website (112) is used as an interface with other supplier websites (114a-114n) that provide goods or services the customer wishes to purchase. In this way, the customer is spared from the need to access and complete transactions at each of the supplier websites (114) individually.

The agent website (112) may include a server that has both processing and memory resources. An e-commerce application is stored in the memory resources of the website (112) and executed by the processing resources of the website (112). An e-commerce application is a piece of software, i.e., computer-readable instructions, that can be executed by the website server to provide the functionality of the website as described herein.

The agent website (112) provides an electronic cross-web shopping cart (111). The cross-web shopping cart (111) is an electronic record of products that the customer has indicated should be purchased from one or more of the supplier websites (114). Consequently, the cross-web shopping cart (111) preferably includes information that identifies each product being purchased, the supplier website (114) from which the product is to be purchased and other information, such as the quantity of the product to purchase, optional characteristics of the product to be purchased, etc. The shopping cart (111) is stored in the memory resources of the server on which the agent website is resident.

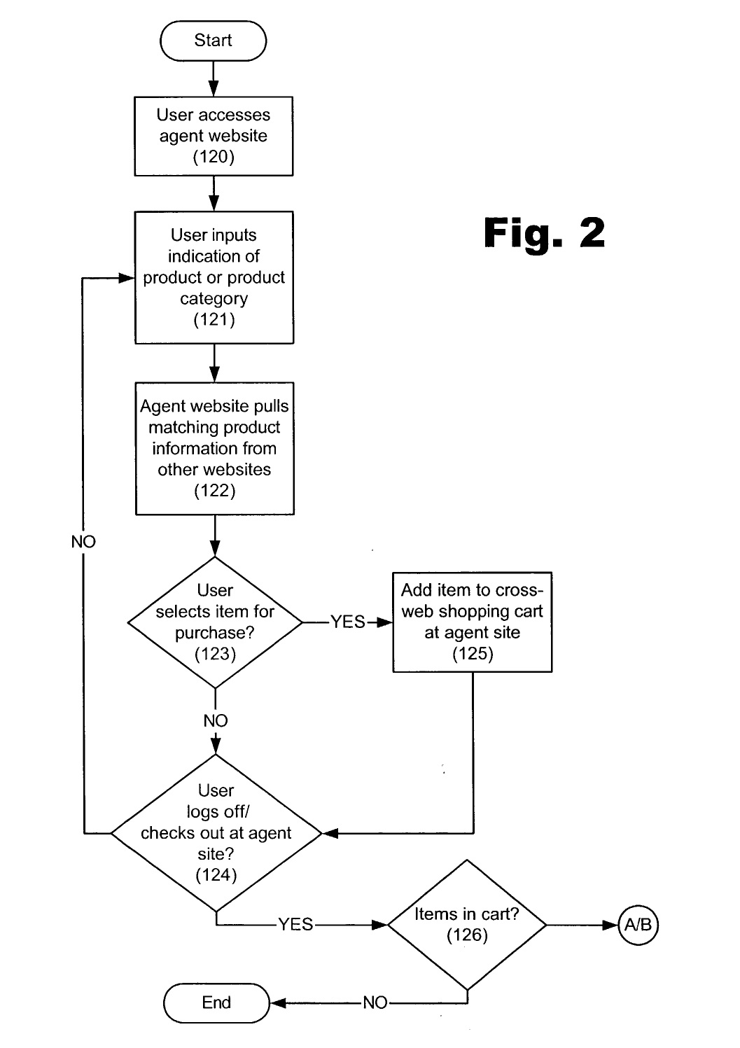

Several possible methods of using the system illustrated in FIG. 1 will be described in detail below with respect to FIGS. 2-5.

As shown in FIG. 2, the customer first accesses the agent website (step 120). This is preferably done using a web browser running on the customer's computer (110, FIG. 1). Using the computer (110, FIG. 1), the customer inputs an indication of the product that is desired and which the customer wishes to consider for purchase (Step 121). This may include browsing an electronic catalog from any of the supplier sites (114, FIG. 1) or a compilation of electronic catalog information combined by the agent website (112, FIG. 1) from two or more of the supplier sites (114, FIG. 1). Providing an indication of the desired product may also entail entering a keyword, product name or product specifications that identify the product the customer wishes to locate.

The indication of the product or products desired is then transmitted to the agent website. It should be noted that, for simplicity, the purchase of products is described herein. However, the embodiments described are equally applicable to the purchase of services from the various supplier websites (114, FIG. 1).

Next, the agent website retrieves product information from one or more of the supplier sites that matches the product parameters provided by the customer (Step 122). Information about the available products corresponding to the customer's criteria is then displayed for the customer at the customer's computer (110, FIG. 1). This information may include, for example, product description and specifications, product photographs or drawings, pricing, availability, comments from other buyers, etc. Any information about the product that is available on the originating supplier site can be delivered directly to the customer's computer or echoed for the customer through the agent site.

The customer may select one or more of the items for purchase (Determination 123). Items that are selected are added (Step 125) to the cross-web shopping cart (111, FIG. 1). Because the shopping cart is resident on the agent website, it does not matter if items from different suppler sites are selected and added to the cart. As indicated above, the cart will contain information indicating from which supplier site the items in the cart are available.

The customer may then continue shopping for additional products or may log off or checkout (Determination 124). If the customer simply logs off without proceeding to checkout, the process ends. In this circumstances, the cross-web shopping cart may be saved by the agent site for later access and use by the customer, but this is not necessarily so.

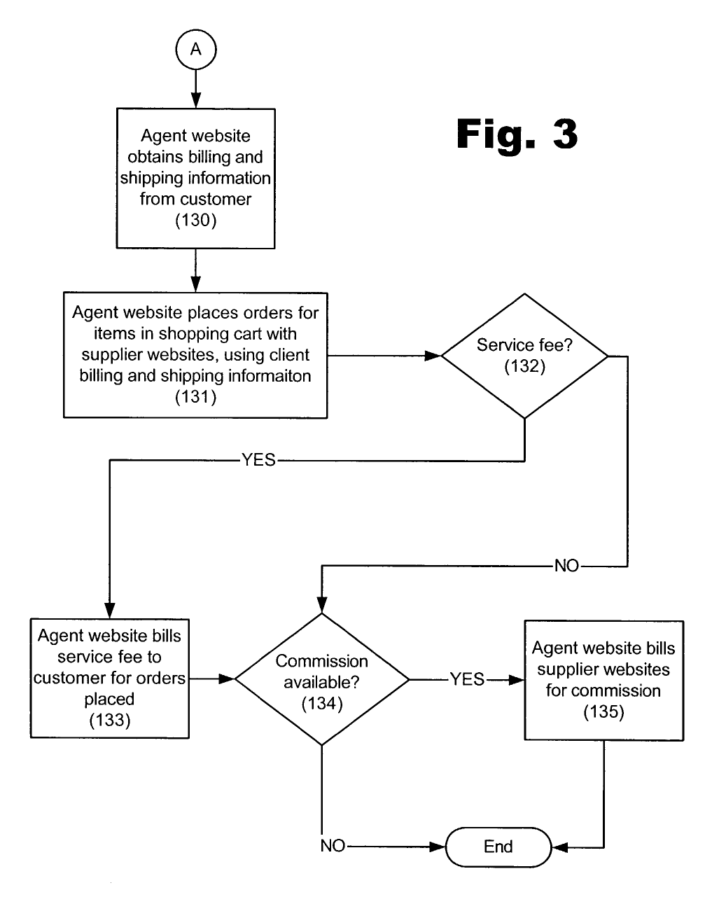

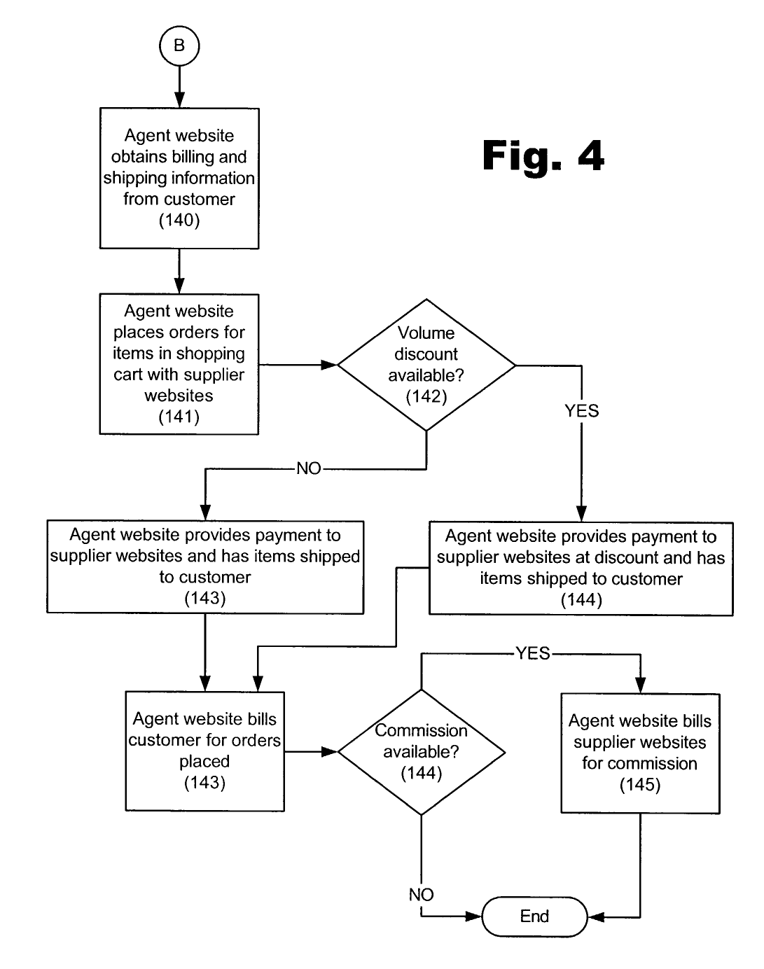

If there are items in the cart (Determination 126) and the customer proceeds to checkout, there are at least two different ways in which the financial aspects of the transaction can be completed. Each of these two payment methods will be described in turn with reference to FIGS. 3 and 4.

As shown in FIG. 3, the agent website may obtain billing and shipping information from the customer (Step 130). Preferably, the agent website obtains this information only once and then stores it for future use by the customer without requiring the customer to re-enter the information. Additionally, the agent website can allow the customer to update the billing and shipping information as needed.

Billing information refers to information used to obtain payment from the customer. Consequently, billing information could include credit card information, monetary account information, and the like. The customer may also have an account with the operators of the agent website that can be prepaid and debited as purchases are made, or the customer may have a line of credit with the agent website against which purchases are made and then periodically billed. If a credit card is used, the agent website may also perform a credit check to make sure that the amount the customer is attempting to purchase will be accepted by the credit card account provided.

Shipping information refers to the address and other information used to ship products to the customer. Shipping information may include a preferred carrier, including price and acceptable shipping time, as specified by the customer.

After this information is obtained, it is used by the agent website to place orders for the items in the cross-web shopping cart with the appropriate supplier website or websites on behalf of the customer (Step 131). In other words, the agent website will transmit the billing and shipping information, as needed, to the supplier websites to place orders for the desired items that will be shipped directly to the customer.

The advantage to the customer is the ability purchase items from a number of supplier sites with only a single transaction using the cross-web shopping cart. The agent website may charge a service fee for providing this service to the customer (Determination 132). If so, the agent website bills the service fee to the customer for the orders placed (Step 133).

The agent website may also be able to collect a commission from the supplier websites for selling products from those websites (Determination 134). If a commission is available, the agent website bills the supplier website or websites for the commission (Step 135).

FIG. 4 illustrates an alternative method of conducting the financial portion of the transaction initiated by the process illustrated in FIG. 2. As shown in FIG. 4, the agent website again obtains billing and shipping information from the customer (Step 140). This step may be identical to step 130 described above and a redundant explanation will be omitted.

After the agent website has acquired the billing information, the agent website places orders with the various supplier sites for the item or items in the cross-web shopping cart (Step 141). In this regard, the agent website does not transmit customer billing information to the supplier site or sites. Rather, the agent website places an order using its own billing information, including, for example, an account established with the supplier site or sites.

The agent website may still have the supplier site or sites ship the ordered products directly to the customer. This will save shipping time. However, the agent website could alternatively take shipment of the order products and then pass the products on to the customer to preserve customer anonymity. In such a case, no customer information need be provided by the agent website to the supplier site. This may be very desirable to a customer who prefers to have the supplier sites unaware of his or her identity so as to prevent the supplier sites from aggressively marketing further products directly to that customer.

The agent website may also be able to negotiate for a volume discount on each purchase made from a supplier site by a customer of the agent website. If a volume discount is available (determination 142), the agent website will provide payment to the supplier site less the agreed discount (step 144). This discount may be passed, in whole or in part, to the customer to encourage the customer to use the agent website. Alternatively, the benefit of the discount may be kept entirely by the operators of the agent website. If no discount is available, the agent website will make payment to the supplier site or sites for the products ordered (Step 143).

The agent website will then bill the customer for the orders placed (Step 143). This billing may include a service fee as described in connection with FIG. 3. The billing of the customer may also be reduced to reflect some or all of a volume discount available from the supplier site or sites to the agent website.

Again, the agent website may be able to collect a commission for the sales to the customer (Determination 144). Where a commission is available, the agent website will bill each supplier site for the commission owed (Step 145).

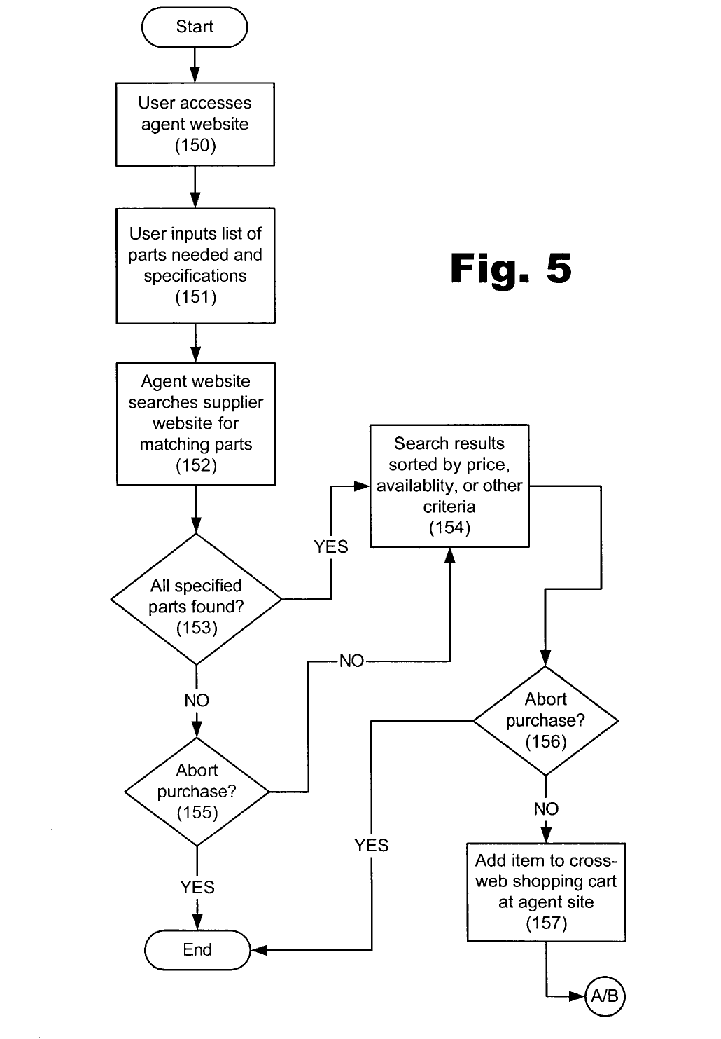

FIG. 5 is a process diagram that illustrates a method of purchasing components from a parts list according to another embodiment of the present invention. In the embodiment of FIG. 5, the agent website is used to acquire a list of needed products or the various components or materials needed by the customer to assembly a product.

As shown in FIG. 5, the customer accesses the agent website (Step 150). This is preferably done in a manner similar to Step 120 of FIG. 2, and a redundant explanation will be omitted.

Next, a list of the products, materials or components (hereinafter “materials list”) is provided to the agent website. This may be done by having the customer enter and transmit a materials list using the customer computer (110, FIG. 1). Alternatively, a variety of materials lists stored in the memory resources of the agent website may be displayed so that the customer can select a pre-existing list for use.

Materials lists are component lists that identify parts or materials required to build or complete a project. The materials lists may be lists of component parts for building or assembling any number of projects, including but in no way limited to personal computer systems, short wave radios, or automobiles. The materials list preferably includes details and parameters that define the items listed. The more detail provided, the better able the agent website will be to match the items on the materials list with items available from the suppler sites.

Once the customer has the opportunity to provide or confirm the materials list with the agent website, the customer may further narrow the scope of possible items that satisfy the list by electing and specifying material characteristics and options. Preferably, the customer is able to select the characteristics that the customer desires for the materials or items on the materials list. Some examples of unique requirements a customer may select include, but are in no way limited to: manufacturer of the item, color of the item, size of the item, price range of the materials, quality of the materials, or style of the item.

Accordingly, the agent website may provide a number of checkboxes indicating known options for each listed item on the materials list that allow the customer to quickly and easily enter parameters for acceptable items. The checkboxes also allow the customer to state whether they are willing to accept out of stock items that may take longer to ship as well as whether they prefer items with rebates, promotions or coupons. Once the customer has selected the desired characteristics for the materials lists, the characteristics are sent to the agent website over the network.

After the desired characteristics are determined by the customer, the materials list is completed by the agent website. The agent website uses a combination of the materials lists and the desired characteristics as sent by the customer to form a web search (Step 152).

The web search preferably includes the customer of a search engine to search the Internet, World Wide Web or other networks for supplier sites containing search terms, to create an index of the supplier sites containing the selected search terms, and then to compare the terms of the search criteria to the created index in order to find relevant sites or items. The agent website may also periodically use existing web-based price search engines to find the lowest available prices for selected items on the material lists. The results from the periodic price search may then be used to form a preferred vendor's list for the selected materials lists.

The web search returns a list of available materials from encountered supply sites that satisfy the parameters of the materials list. As will be discussed below, the available materials may be listed according to any number of criteria including, but not limited to part-by-part listing, total cost listing, availability or manufacturer listing.

It is, however, possible that the web search is performed without identifying a potential source for all of the items on the materials list. This may be especially true if the customer included a number of restrictive characteristics in the search. If the agent website determines that all of the items on a materials list are not offered for sale at the supplier sites searched (determination 153), the customer is informed of the lack of matches and is allowed to decide whether to proceed with purchase of individual components from the results of the web search or whether to cancel the entire transaction (Step 155).

If the customer decides to cancel the entire transaction, any purchase data corresponding to the materials list are preferably deleted from the customer's cross-web shopping cart. However, if the customer decides to pick and choose from among the available materials resulting from the web search, the customer is able to access a list of the web search results (Step 154) and select desired items. Once selected, purchase data corresponding to the desired materials is entered into the cross-web shopping cart (Step 157) in preparation of purchase.

When the agent website receives the list of available materials, the agent website preferably sorts the results of the web search according to such criteria as pricing, shipping, and availability of each individual part. The sorting criteria are preferably entered or selected by the customer. Preferably, the list may be re-sorted based on different criteria whenever desired by the customer. The pricing used to rate the list of results from the web search preferably includes both shipping and handling. Shipping and handling are included in the above-mentioned pricing list in order to prevent the online purchaser from being misinformed about the actual cost of each item. Additionally, if an item is offered with rebates, promotions, or coupons, the agent website may present both the pre-discount cost and the post-discount cost to the customer.

The customer can then evaluate which of the available materials the customer would prefer to purchase to satisfy the materials list. If the options are unacceptable, the customer may again have the option of aborting the purchase (Determination 156).

Once the customer has evaluated the available materials, desired materials may be selected and purchase data relating to the selected materials may be placed into the cross-web shopping cart in preparation for purchase (Step 157). As before, the desired items may all be placed in the same cart regardless of the source or type of item.

When a finalized list of materials to be purchased by the customer is entered into the cross-web shopping cart, the agent website presents a total price of the selected materials to the customer. The price presented to the customer, as determined by the agent website, preferably includes the purchase price from the supplying site and the shipping and handling costs associated with all of the items contained in the cross-web shopping cart, plus any service fees charged by the agent website. The customer may also be presented with a constant running total of the cost of the selected items stored in the cross-web shopping cart including shipping, handling, service fees and any potential discount offered by the supplier website or item manufacturer.

Once the purchase data for the items the customer desires to purchase have been added to the cross-web shopping cart, the financial portion of the transaction can proceed, for example, along the lines illustrated in FIG. 3 or FIG. 4. A redundant explanation of those figures will be omitted.

In an alternative embodiment, the agent website automatically assigns the most inexpensive materials matching the parameters of the materials list to the customer's cross-web shopping cart. Consequently, according to this alternative embodiment, a single selection by the customer of a materials list will fill the customer's cross-web shopping cart with the purchase data associated with the most inexpensive materials that match the list parameters.

In an additional embodiment, the agent website allows the customer to prevent the agent website from searching for list items on individual supplier websites as determined by the customer. According to this embodiment, the customer is prompted for a list of websites that the customer refuses to make purchases from. This information is sent to the agent website along with the selected material characteristics and requirements. Once the list of precluded supplier sites is received by the agent website, they are used as restrictions to the web search, thereby preventing the search engine from returning search results from to the precluded websites.

The preceding description has been presented only to illustrate and describe the invention. It is not intended to be exhaustive or to limit the invention to any precise form disclosed. Many modifications and variations are possible in light of the above teaching. It is intended that the scope of the invention be defined by the following claims.

What is claimed is:

1. A method of making purchases over a computer network, the method comprising:
accessing an agent site on the network;
retrieving product information from at least one supplier site on the network; and
recording information regarding products designated for purchase from supplier sites in an electronic shopping cart resident at the agent site.

2. The method of claim 1, further comprising entering customer billing and shipping information to the agent site.

3. The method of claim 2, further comprising sending the customer billing information from the agent site to at least one supplier site to place an order with the supplier site for an item in the shopping cart.

4. The method of claim 3, further comprising collecting a commission from the supplier site for the order.

5. The method of claim 3, further comprising charging a service fee for placing the order.

6. The method of claim 3, further comprising sending the customer shipping information from the agent site to the supplier site as part of the order to have the supplier site ship an ordered product directly to a customer of the agent site.

7. The method of claim 2, further comprising:
placing an order from the agent site with a supplier site for an item in the shopping cart without transmitting the customer billing information to the supplier site; and
billing a customer for the order using the customer billing information.

8. The method of claim 7, further comprising receiving a discount for the order from the supplier site.

9. The method of claim 7, further comprising collecting a commission from the supplier site for the order.

10. The method of claim 7, further comprising charging a service fee for placing the order.

11. The method of claim 7, further comprising sending the customer shipping information from the agent site to the supplier site as part of the order to have the supplier site ship an ordered product directly to a customer of the agent site.

12. The method of claim 1, further comprising establishing a materials list of items to be purchased, wherein retrieving product information further comprises matching products available at supplier sites with items on the materials list.

13. The method of claim 12, wherein the materials list contains parameters defining each listed item, wherein the retrieving product information further comprises matching products available at supplier sites with the parameters from the materials list.

14. The method of claim 13, further comprising:
presenting information to a customer on matching products that match the parameters from the materials list; and
receiving customer input selecting among alternative matching products.

15. The method of claim 14, further comprising sorting the information on matching products by customer-selected criteria.

16. The method of claim 12, further comprising filling the shopping cart with a lowest priced alternative for each item on the materials list available from the supplier sites.

17. A website comprising a server connected to a computer network and executing an e-commerce application that causes the server to:
retrieve product information from at least one supplier site on the network; and
record information regarding products designated for purchase from supplier sites in an electronic shopping cart resident on the server.

18. The website of claim 17, wherein the e-commerce application further causes the server to receive customer billing and shipping information.

19. The website of claim 18, wherein the e-commerce application further causes the server to send the customer billing information to at least one supplier site to place an order with the supplier site for an item in the shopping cart.

20. The website of claim 19, wherein the e-commerce application further causes the server to send the customer shipping information to the supplier site as part of the order to have the supplier site ship an ordered product directly to a customer.

21. The website of claim 18, wherein the e-commerce application further causes the server to place an order with a supplier site for an item in the shopping cart without using the customer billing information.

22. The website of claim 21, wherein the e-commerce application further causes the server to bill a customer for the order using the customer billing information.

23. The website of claim 21, wherein the e-commerce application further causes the server to send the customer shipping information to the supplier site as part of the order to have the supplier site ship an ordered product directly to a customer of the agent site.

24. The website of claim 17, wherein the e-commerce application further causes the server to:
establish a materials list of items to be purchased; and
while retrieving product information, match products available at supplier sites with items on the materials list.

25. The website of claim 17, wherein the materials list contains parameters defining each listed item, and wherein the c-commerce application further causes the server to match products available at supplier sites with the parameters from the materials list.

26. The website of claim 25, wherein the e-commerce application further causes the server to:
present information to a customer on matching products that match the parameters from the materials list; and
receive customer input selecting among alternative matching products.

27. The website of claim 26, wherein the e-commerce application further causes the server to sort the information on matching products by customer-selected criteria.

28. The website of claim 24, wherein the e-commerce application further causes the server to fill the shopping cart with a lowest priced alternative for each item on the materials list available from the supplier sites.

29. A system for making purchases over a computer network, the system comprising:
means for accessing an agent site on the network;
means for retrieving product information from at least one supplier site on the network; and
means for recording information regarding products designated for purchase from supplier sites in an electronic shopping cart resident at the agent site.

30. The system of claim 29, further comprising means for transmitting customer billing and shipping information to the agent site.

31. The system of claim 30, further comprising means for sending the customer billing information from the agent site to at least one supplier site to place an order with the supplier site for an item in the shopping cart.

32. The system of claim 31, further comprising means for sending the customer shipping information from the agent site to the supplier site as part of the order to have the supplier site ship an ordered product directly to a customer of the agent site.

33. The system of claim 31, further comprising means for charging a service fee for placing the order.

34. The system of claim 30, further comprising means for placing an order from the agent site with a supplier site for an item in the shopping cart without using the customer billing information.

35. The system of claim 34, further comprising means for billing a customer for the order using the customer billing information.

36. The system of claim 34, further comprising means for charging a service fee for placing the order.

37. The system of claim 34, further comprising sending the customer shipping information from the agent site to the supplier site as part of the order to have the supplier site ship an ordered product directly to a customer of the agent site.

38. The system of claim 29, further comprising means for establishing a materials list of items to be purchased, wherein the means for retrieving product information further comprises means for matching products available at supplier sites with items on the materials list.

39. The system of claim 38, wherein the materials list contains parameters defining each listed item, wherein the means for retrieving product information further comprises means for matching products available at supplier sites with the parameters from the materials list.

40. The system of claim 39, further comprising:
means for presenting information to a customer on matching products that match the parameters from the materials list; and
means for receiving customer input selecting among alternative matching products.

41. The system of claim 40, further comprising means for sorting the information on matching products by customer-selected criteria.

42. The system of claim 38, further comprising means for filling the shopping cart with a lowest priced alternative for each item on the materials list available from the supplier sites.
